(19) United States
(12) Patent Application Publication
(10) Pub. No.: US 2016/0078415 A1
(43) Pub. Date: Mar. 17, 2016

(54) METHOD AND APPARATUS FOR DIGITAL TICKET INSPECTION

(71) Applicant: NOKIA TECHNOLOGIES OY, Espoo (FI)

(72) Inventors: Jan-Erik EKBERG, Vantaa (FI); Jarkko SEVANTO, Helsinki (FI)

(73) Assignee: Nokia Technologies Oy

(21) Appl. No.: 14/785,414

(22) PCT Filed: Apr. 23, 2013
(86) PCT No.: PCT/FI2013/050454

§ 371 Date: Oct. 19, 2015

(51) Int. Cl. G06Q 20/04; G07F 17/00; G06Q 20/40; G06Q 20/32; G06Q 20/38

(52) U.S. Cl. CPC G06Q 20/0453; G06Q 20/3278; G06Q 20/38215; G06Q 20/401; G07F 17/0021; G06Q 2220/00

(57) ABSTRACT

A method, apparatus and computer software are disclosed, with obtaining from a backend (130) cryptographic information configured to enable digital inspection of whether credential information shows a valid digital ticket; and sending the received cryptographic information to a digital ticket inspection member (142) for verifying of validity of credential information of user devices (110) by the digital inspection member (142) or causing receiving of credential information from the digital inspection member (142) and verifying of validity of the credential information.

### TECHNICAL FIELD

The present application generally relates to digital ticket inspection.

### BACKGROUND

Public transport is usually cost-bearing. Tickets are purchased and used by passengers to evidence valid payment for a journey when requested by a ticket inspector. In case of physical tickets made of paper or cardboard, the appearance of the ticket and text printed on the ticket authenticate the ticket and show its valid term, range or further authentication information.

If paper tickets were directly digitized, such digital tickets would consist of digital information that by default can be perfectly copied. Therefore, various cryptographic measures have been developed. For instance, the ticket holder may be provided with a smart card or corresponding functionality in her mobile device. In particular, smart cards typically use a challenge-response mechanism that is based on a) cryptographic algorithm(s), b) private secret stored within the smart card, c) shared secret stored by the smart card and a back-end entity, and d) changing sequence number or random number embedded in the challenge and response to prevent reuse of old messages.

Inspection of digital tickets is typically performed correspondingly with that of paper tickets: an inspector asks to see a ticket and checks the validity of the ticket based on the properties of a valid ticket. Whereas these properties are visually verified in case of a paper ticket using knowledge of the ticket inspector, the verification of digital tickets is performed using a digital ticket inspection device that digitally communicates with a digital ticket holder device. In case of a near-field communication (NFC) based ticket holder device, the digital ticket holder device must be brought next to the digital ticket inspection device.

### SUMMARY

Various aspects of examples of the invention are set out in the claims.

According to a first example aspect of the present invention, there is provided an apparatus, comprising:

a communication interface;

a memory; and

a processor configured to:
cause obtaining by the communication interface of credential information from a user device for digital ticket inspection;
cause storing of the credential information or a derivative thereof in the memory;
cause communicating by the communication interface to a digital ticket inspection device the credential information or the derivative thereof.

According to a second example aspect of the present invention, there is provided an apparatus, comprising:

a first communication interface;

a second communication interface;

a processor configured to:
cause using the first communication interface to obtain from a back-end cryptographic information configured to enable digital inspection of whether credential information shows a valid digital ticket; and
cause sending the received cryptographic information using the second communication interface to a digital ticket inspection member for verifying of validity of credential information of user devices by the digital inspection member or cause:
   receiving of credential information using the second communication interface from the digital inspection member and verifying of validity of the credential information by the processor.

According to a third example aspect of the present invention, there is provided a method comprising:
obtaining credential information from a user device for digital ticket inspection;
storing the credential information or a derivative thereof; and
communicating to a digital ticket inspection device the credential information or the derivative thereof.

According to a fourth example aspect of the present invention, there is provided a method comprising:
obtaining from a back-end cryptographic information configured to enable digital inspection of whether credential information shows a valid digital ticket; and
sending the received cryptographic information to a digital ticket inspection member for verifying of validity of credential information of user devices by the digital inspection member or causing:
   receiving of credential information from the digital inspection member and verifying of validity of the credential information.

According to a fifth example aspect of the present invention, there is provided an apparatus comprising:

a memory comprising cryptographic information;

a third communication interface configured to communication with the first interface of the apparatus of the second example aspect; and

a processor configured to cause the third communication interface to provide the first communication interface with back-end cryptographic information that is configured to enable digital inspection of whether credential information shows a valid digital ticket.

According to a sixth example aspect of the present invention, there is provided a method comprising:

storing cryptographic information;

communicating to an apparatus that is performing the method of the third example aspect back-end cryptographic information that is configured to enable digital inspection of whether credential information shows a valid digital ticket.

According to a seventh example aspect of the present invention, there is provided a computer program, comprising:
code for obtaining credential information from a user device for digital ticket inspection;
code for storing the credential information or a derivative thereof; and
code for communicating to a digital ticket inspection device the credential information or the derivative thereof;

when the computer program is run on a processor.

According to an eighth example aspect of the present invention, there is provided a computer program, comprising:

code for obtaining from a back-end cryptographic information configured to enable digital inspection of whether credential information shows a valid digital ticket; and

code for sending the received cryptographic information to a digital ticket inspection member for verifying of validity of credential information of user devices by the digital inspection member or causing:
code for receiving of credential information from the digital inspection member and verifying of validity of the credential information.

The computer program of any preceding example aspects may be a computer program product comprising a computer-readable medium bearing computer program code embodied therein for use with a computer.

According to a ninth example aspect of the present invention, there is provided a computer-readable medium encoded with instructions that, when executed by a computer, perform the method of any of the preceding example aspects.

Any foregoing memory medium may comprise a digital data storage such as a data disc or diskette, optical storage, magnetic storage, holographic storage, opto-magnetic storage, phase-change memory, resistive random access memory, magnetic random access memory, solid-electrolyte memory, ferroelectric random access memory, organic memory or polymer memory. The memory medium may be formed into a device without other substantial functions than storing memory or it may be formed as part of a device with other functions, including but not limited to a memory of a computer, a chip set, and a sub assembly of an electronic device.

Different non-binding example aspects and embodiments of the present invention have been illustrated in the foregoing. The embodiments in the foregoing are used merely to explain selected aspects or steps that may be utilized in implementations of the present invention. Some embodiments may be presented only with reference to certain example aspects of the invention. It should be appreciated that corresponding embodiments may apply to other example aspects as well.

### BRIEF DESCRIPTION OF THE DRAWINGS

For a more complete understanding of example embodiments of the present invention, reference is now made to the following descriptions taken in connection with the accompanying drawings in which:

FIG. 1 shows an architectural overview of a system of an example embodiment of the invention;

FIG. 2 shows a flow chart illustrating a ticket inspection process according to an example embodiment;

FIG. 3 shows a process of an example embodiment in the user device

FIG. 4 illustrates a process in the ticket inspection device and in the ticket inspection member, according to an example embodiment;

FIG. 5 shows a process for validation of time and place relevance or sensibility of the credential information; and

FIG. 6 shows a block diagram of an apparatus that is suitable for use as a user device or as an inspection member; and

FIG. 7 shows a block diagram of an apparatus that is suitable for use as an inspection device or as a back-end server.

### DETAILED DESCRIPTION OF THE DRAWINGS

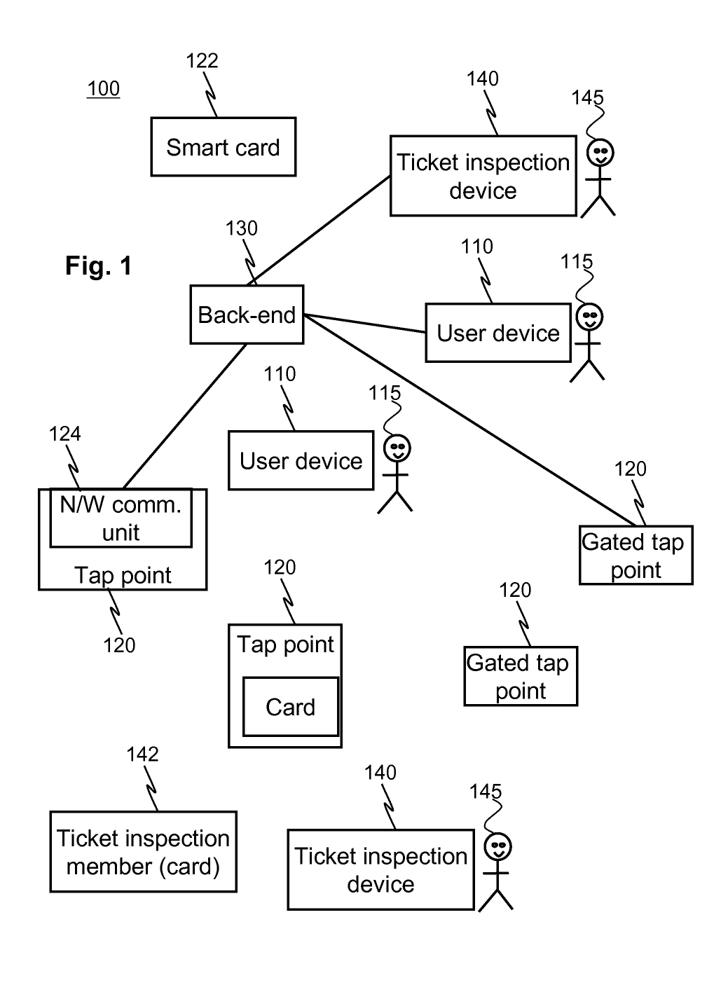

An example embodiment of the present invention and its potential advantages are understood by referring to FIGS. 1 through 7 of the drawings. In this document, like reference signs denote like parts or steps.

FIG. 1 shows an architectural overview of a system 100 of an example embodiment of the invention. The system comprises a user device 110 that is capable of operating as a digital ticket holder device. The system further comprises a plurality of digital ticket validation points 120, also referred to as tap points for brevity of description. The system further comprises a back-end 130.

The user devices 110 are held by users 115 when a digital ticket is needed. The system further comprises one or more digital ticket inspection devices 140 and digital ticket inspection members 142 such as smart cards in one example embodiment for use by inspection persons or inspectors 145. The digital ticket inspection members 142 have in one example embodiment varying implementations whereas in another example embodiment each of the digital ticket inspection members 142 have similar or identical implementation. For example, a digital inspection member 142 can be a near field communications based device. The digital ticket inspection member 142 can be configured to obtain its operation power from the near field communications. The digital ticket inspection member 142 is provided in one example embodiment with a display and/or speaker for respectively providing visual and/or audible information to persons.

It is appreciated that in the digital ticketing, there need not be any particular digital ticket-like file possessed by the user device 110. Instead, the user device 110 of one example embodiment is merely configured to produce evidence of the use of cost-bearing service (e.g. use of given tap points 120) for storing by either or both the user device 110 and one or more other devices such as tap points 120 or the back-end 130. If all the information is communicated in real-time to the back-end 130, then ticket inspection can be simply performed by querying the back-end 130. However, it is not always possible or feasible to implement a ticket system based on continuous real-time connections. In such a case, ticket inspection could not always be based on such querying. It is also often desirable to immediately detect persons without valid ticket on ticket inspection. Otherwise it might be impossible to identify their identity and to impose any penalty for abuse of the ticket system. To this end, in an example embodiment, the user devices 110 are provided by the tap points 120 with credential information. The credential information is e.g. such that it enables proving of validity of a ticket on ticket inspection even when communications with the back-end 130 were not possible by one or more of the user device 110 in question, the tap point 120 used, and/or the equipment used for ticket inspection (e.g. ticket inspection device 140, inspection member 142). In such an example embodiment, the ticket inspection comprises obtaining and verifying the credential information based on off-line information. The off-line information in question comprises for example, a shared secret, one or more challenges, responses to such challenges and/or predetermined sequence number or numbers, and/or any other information suited for this purpose.

It should be understood that while term real-time was used in the foregoing to explain one technical implementation, some embodiments could as well use batch communications in which information is sent e.g. periodically with fixed or variable intervals such as few seconds, one or more minutes or whenever a given amount of information has accrued or a given interval has lapsed since previous communication.

In an example embodiment, some or all of the tap points 120 comprise a smart card 122 configured to co-operate with the user device 110. In a further example embodiment, the smart card 122 is configured to relay data concerning other user devices 110 for relaying by subsequently interacting user devices 110 to the back-end 130. In effect, users of the system 100 will then transfer evidence concerning other users from the tap points 120 to the back-end 130 so that the tap points 120 would not necessary need a communication connection with the back-end 130. Such tap points 120 can be referred to as off-line tap points. On the other hand, in an example embodiment, some or all of the tap points 120 comprise a networked communication unit 124 that is communicatively connected with the back-end 130. Such tap points 120 can transfer usage evidence independently of the user devices 110.

In an example embodiment, in which the system 100 is used in a public transport system or another system in which it may be desirable to inhibit access of non-paying users to given areas (e.g. cinemas, fair venues, concert halls and sport stadiums), some or all of the tap points 120 are so-called gated tap points 120 i.e. there is an automated gate that opens when a valid ticket is presented at the tap point 120.

In FIG. 1, some of the drawn elements are connected by a line to the back-end 130 in illustration of a present data transfer connection. Some elements can be solely off-line operable or in communication connection only part time.

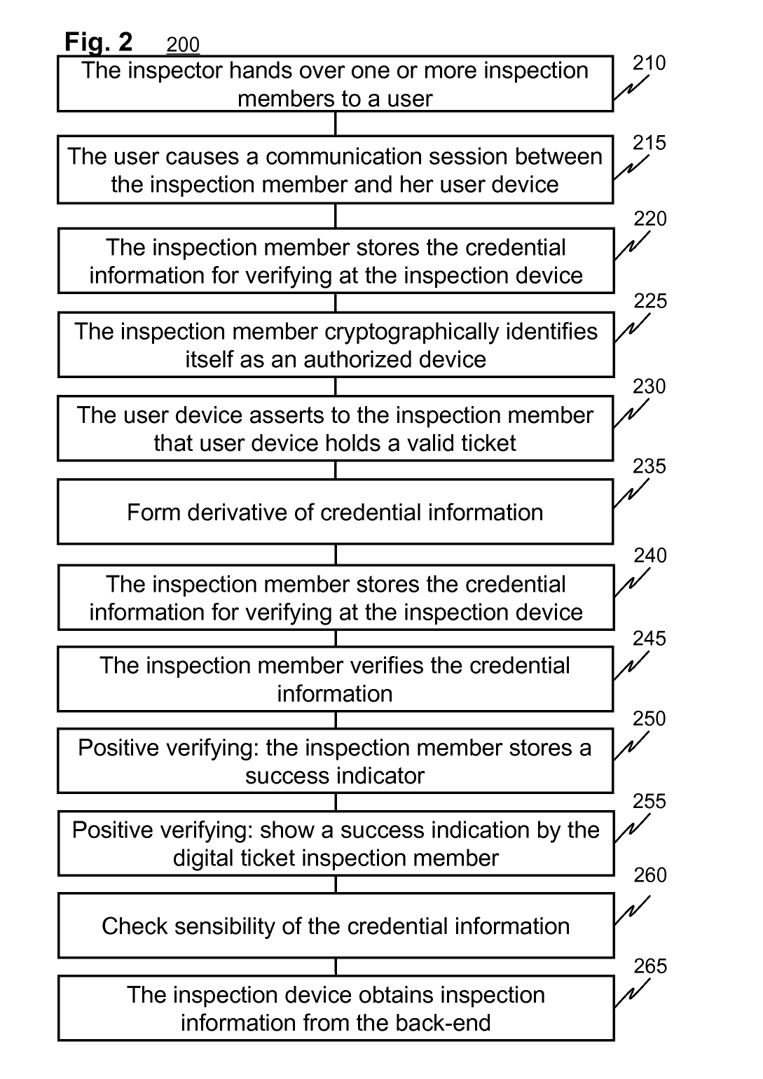

FIG. 2 shows a flow chart illustrating a ticket inspection process 200 according to an example embodiment.

In sake of example, it is assumed that a user 115 has tapped her user device 110 at a tap point 120 and her user device 110 has been provided by the tap point with some tap point information. Moreover, the her user device 110 comprises in an example embodiment some user information such as a user identity indicative of an authorized person or user whom the user device 110 can provide a ticket; ticket term (e.g. given period in years, months, days, hours and/or minutes); ticket subject (e.g. any or given underground services, bus services, tram services, and/or train services); and/or ticket restrictions and/or conditions (e.g. student or handicap discount, off-peak time use, validity only in presence of given accompanying person). The user device 110 also comprises in an example embodiment a shared secret and/or a private secret.

The ticket inspection process starts from step 210 in which the inspector 145 hands over the inspection member 142 to a user 115. The user 115 causes 215 a communication session between the inspection member 142 and her user device 110 e.g. by bringing these two to proximate connection, e.g. one against another, if near field communications are used, to a wired connection e.g. by connecting a plug if wired communications are used, and/or by suitably aligning optical information transmission ports of the user device 110 and of the inspection member 142.

In an example embodiment, the inspection member 142 cryptographically identifies 220 itself as an authorized device to which the user device 110 should issue the credential information so as to avoid man-in-the-middle attacks.

In an example embodiment, the inspection member 142 stores 225 the credential information for verifying 245 at the inspection device 140. In this example embodiment, the inspection member 142 need not necessarily perform any verifying 245 of the credential information.

In the communication session, the user device 110 asserts 225 to the inspection member 142 that user device 110 holds a valid ticket or information indicative of existence of a valid ticket of the user 115. For instance, the inspection member 142 obtains credential information from the user device 110. In an example embodiment, the inspection member 142 forms 235 a derivative of the credential information. For example, the credential information can be decrypted and/or the challenge used for obtaining the credential information can be stored with or the credential information or as a part of the credential information. As another example, the derivative can be a success or failure indication that optionally comprises an identity of a user 115 or user device 110 concerned or a ticket identity or other identification that can indirectly indicate the user 115 or user device 110 concerned.

In an example embodiment, in step 240, the inspection member 140 obtains the credential information from the inspection member 142.

In an example embodiment, the inspection member 142 verifies 245 the credential information. The verifying 245 comprises, for example, checking of a cryptographic checksum; performing a challenge-response process the success of which is only possible for a holder of a valid ticket; decrypting ticket information contained by the credential information and optionally identifying that the decrypted ticket information is associated with the user device 110 in question; comparing time stamp or serial number contained by the credential information; and/or performing any other cryptographic or other operation known for verifying authenticity of an assertion such as the credential information.

If the verifying 245 of the credential information is positive i.e. the credential information indicates a valid ticket for the service being provided for the user 115, e.g. for currently used transport service, the inspection member 142 stores 250 in an example embodiment a success indicator. At this time, in an example embodiment the inspection member 142 purges the corresponding credential information. The success indicator can be stored by increasing a counter, by storing an identifier of the user 115 or of the user device 110, or in any other way depending on implementation.

In an example embodiment the digital ticket inspection member 142 is configured to show 255 a success indication. For instance, if the ticket inspection member 142 has a display or other visual indicator, the user 115 can indicate by the ticket inspection member the validity of her ticket by letting the inspector 145 see the success indication on the inspection member 142. Correspondingly, the inspection member 142 can be configured to issue an audible success indication for the user 115 and/or for the inspector 145.

In an example embodiment, the success indication is a sequence number that shows the number of successfully verified 245 credential information. In this case, the inspector 145 may simply memorize or store the initial sequence number, pass the inspection member 142 through a number of users 115 and then compare the final sequence number with the initial sequence number plus the number of users 115 through whom the inspection member 142 has been passed. If all the users 115 had a valid ticket and successfully verified her or his ticket to the inspection member 142, then the final sequence number matches; otherwise the inspector can start checking the user devices 110 one by one unless a person or persons without valid ticket voluntarily identify themselves at this stage.

In an example embodiment, the ticket inspection member is configured to indicate the sequence number of the user device 110 the verifying 245 failed e.g. because of expiry of ticket. For example, the inspection member could show a message “Recheck the ticket of the third person”.

There are also various different example embodiments for immediate indication of a valid or invalid verifying 245 of the credential information. For instance, the inspection member 142 and/or the user device can be configured to issue an audible or visual signal in response to positive verifying 245 and/or to negative verifying 245. The inspection member 142 can also be provided with a theft-protection feature. For instance, the inspection member 142 can be configured to issue a clear audible and/or visual signal if the an interval exceeding a threshold has lapsed since the inspection member 142 has previously been used for a positive verifying 245, until accessed by the inspector's 145 inspection device 140.

In some example embodiments, the inspection member 142 does not contain any output for audible and visual signals. Instead, the inspection member 142 is returned after the verifying 245 at each user's 115 user device and read or accessed by the inspection device 140 by the inspector 145. The inspection device 140 may then operate as a user interface for the inspection member 142.

In an example embodiment, the verifying 245 of the credential information comprises a step 260 in which the sensibility of the credential information is checked. The checking of the sensibility involves, for example, comparing the time and/or position with the present time and/or position and taking into account possible intermediate tap points 120 at which the user device 110 has been used i.e. information of which are stored by the user device 110 and which are indicated by the credential information.

In an example embodiment, the inspection device 140 obtains 265 from the back-end 130 inspection information. This step can occur manually and/or automatically e.g. with predetermined intervals; on given stage of each trip or other usage of the inspection device 140 such as interaction with the inspection member 142; and/or on obtaining a connection with the back-end 130 e.g. over a wired or wireless communication channel such as cellular connection, wireless local area network, Bluetooth™ or WiMAX™ connection.

The inspection information comprises in an example any one or more of: current time; current location; timetable information; one or more challenges; public keys of one or more user devices; shared secret or a derivative thereof; identities of black-listed user devices 110; and identities of black-listed users 115.

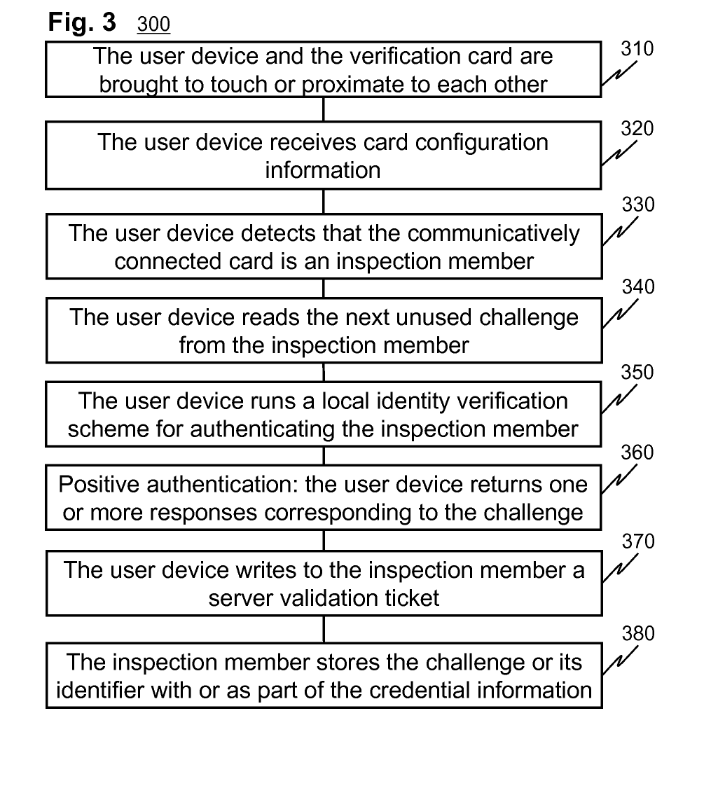

FIG. 3 shows a process of an example embodiment in the user device 110. It is again assumed that the user device 110 is a near field communications enabled device, although any other communication techniques could be used with suitable modifications, as with other example embodiments.

In step 310, the user device 110 and the verification card are brought to touch or proximate to each other. In step 320 e.g. by a response to a ISO 7816 SELECT. In step 330, the user device notices that the communicatively connected card is an inspection member 142. In step 340, the user device reads the next unused challenge from the inspection member 142. In step 350, the user device 110 runs locally, e.g. with its trusted execution environment TEE, an identity verification scheme for authenticating the inspection member 142 so as to avoid compromising its own information security. If the inspection member 142 is positively authenticated, the user device 110 returns 360 one or more responses corresponding to the challenge to the inspection member 142. These one or more responses can form the credential information or a certificate and signature response to the inspection member 142. The user device 110 writes 370 the server validation ticket (received as a response to the tap-in event the user did when she initiated her travel) to the inspection member 142. If server validation is not received due to connection issues, the user device 110 writes all evidence received at tap-in to the inspection card 142 instead. In an example embodiment, the transport certificate is written by the user device 110 to the inspection member 142 with an associated certificate that contains a thumbnail picture of the user 115.

In an example embodiment, the inspection member stores 380 the challenge or an identifier thereof with or as part of the credential information. The storing of the information of the challenge used can be used to help subsequent checking of the credential information e.g. by enabling testing that the credential information has been formed making use of the correct challenge.

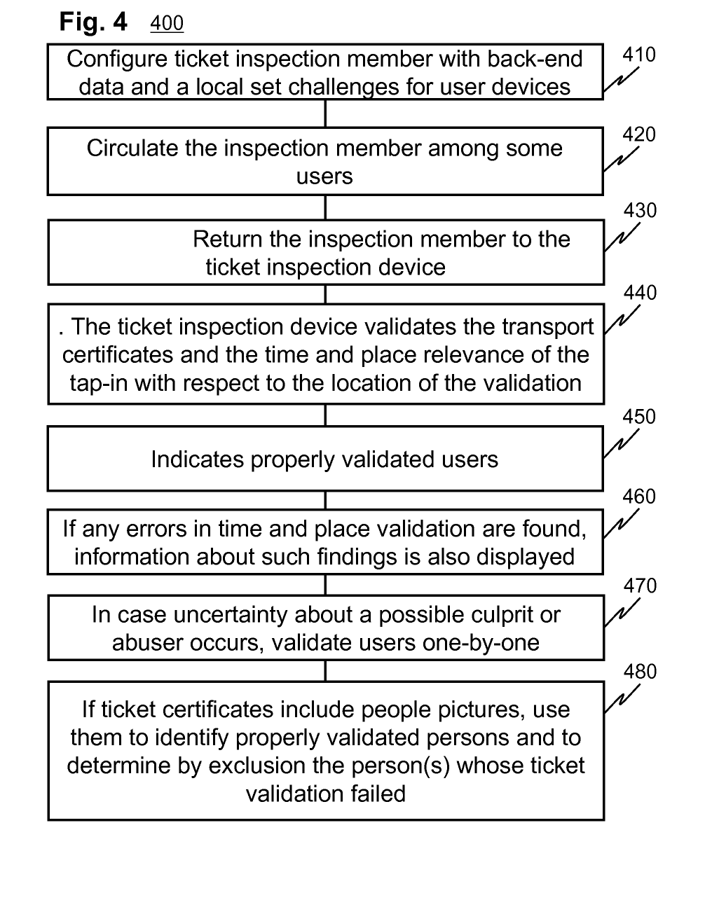

FIG. 4 illustrates a process 400 in the ticket inspection device 140 and in the ticket inspection member 142, according to an example embodiment.

In the process 400, the smart card or ticket inspection member 142 is configured 410 with back-end data and a local set of e.g. 10 random challenges to be consumed by user devices 110. The smart card 142 is circulated 420 among some customers or users 115 e.g. among 4 or 5 people sitting in one segment of a local train for obtaining the credential information for use as transport certificates. The smart card 142 is returned 430 to the ticket inspection device 140. The ticket inspection device 140 (or the smart card 142) validates 440 the transport certificates and the time and place relevance of the tap-in with respect to the location of the validation (explained with more detail in following text). Ticket inspection user interface, i.e. user interface on the ticket inspection device 140 and/or on the inspection member 142, indicates 450 properly validated users or e.g. how many persons were properly validated. If any errors in time and place validation are found, information about such findings is also displayed 460. If the number of validated people matches the number of physical people being validated, the inspection is continued by the inspector from step 420 by circulating the smart card 142 to a new group of one or more people. In case uncertainty about a possible culprit or abuser occurs, people in a certain segment can be validated one-by-one 470 until the one with an non-conforming ticket (or without a ticket) is found. If ticket certificates include people pictures, these can be used in the ticket inspection device to identify properly validated persons and by to determine exclusion the person or persons whose ticket validation failed, step 480.

As mentioned with reference to FIG. 3, the ticket inspection member 142 can be equipped with its own display or other optical and/or acoustic indicators for monitoring whether each person's user device 110 can present a valid credential information to the ticket inspection member.

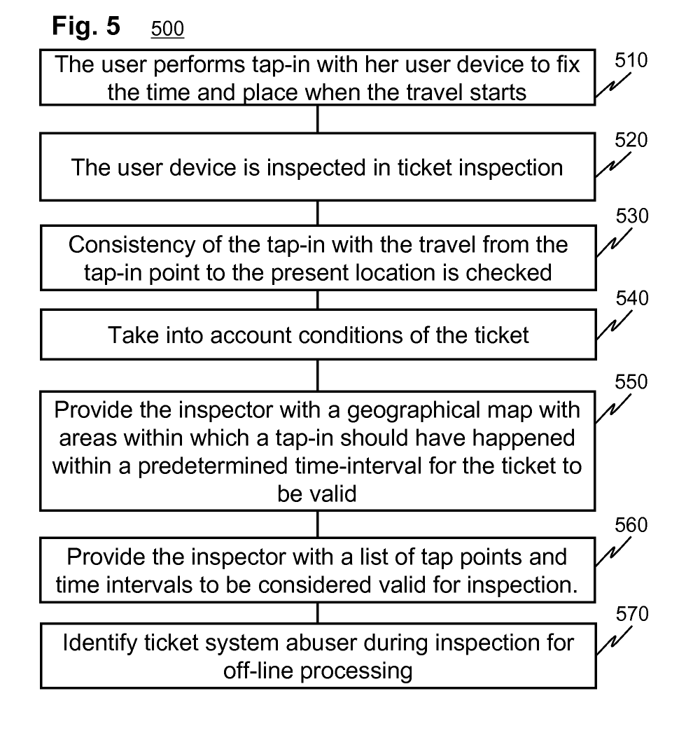

FIG. 5 shows a process 500 for validation of time and place relevance or sensibility of the credential information. It is understood that in an open transport system that charges for the exact travel being done, there is a danger that some people may abuse the system so that they do roundtrip travel but only log (tap-in, tap-out) a very short trip in the vicinity of the starting point. The process of FIG. 5 is directed to catch by ticket inspection such culprits on the return trip as follows.

In step 510, the user 115 performs tap-in with her user device 110 to fix the time and place when the travel starts. In step 520, the user device is inspected e.g. as described in the foregoing. It is verified 530 that the tap-in was consistent with the travel from the tap point 120 in question to the present location in which the inspection is being carried out. In an example embodiment, a consistency check comprises detecting of one or more parameters from the credential information; comparing the parameter(s) with given acceptable range or ranges (e.g. smallest and greatest possible delay since tap-in, smallest and greatest possible distance from tap-in point). Generally speaking, the distance from the tap point 120 towards the travel destination should increase. Moreover, a certain average speed of travel can be assumed in a transport system. Based on that average speed, a minimum sensible travel can be calculated by multiplying the average speed with the time elapsed since the tap-in at the tap point 120. In some cases, the credential information provided by the user device 110 on ticket inspection is bound to a given service or time of travel. For instance, a price discount may be granted on condition that the travel avoids particularly congested nodes or hours. The user 115 may be required to tap-in at given intermediate tap points 120 in order to prove that she has avoided forbidden segments, nodes and rush hours as prescribed by conditions of her present ticket. The inspection at the inspection member 142 and/or at the inspection device 140 can correspondingly then account 540 for the conditions of the ticket.

In an example embodiment, the inspector is provided 550 e.g. via the inspection device 140 with a geographical map with areas within which a tap-in should have happened within a predetermined time-interval in order to be considered a valid tap for inspection. For instance, the predetermined time-intervals for this purpose can be fifteen minutes, half an hour, hour or even two hours, depending on the area in which the transport system of this example extends and on the average speeds therein.

In an example embodiment, the inspector is provided 560 e.g. via the inspection device 140 with a list of tap points (locations) and time intervals that are considered valid for inspection.

In an example embodiment, the sensibility of tickets is checked at the back-end 130 in addition or instead of the inspection member 142 or inspection device 140. Indeed, if the inspector fines people who travel completely without a ticket, the abuse of a ticket processed off-line between relevant authorities and the identified customer based on the evidence collected at ticket inspection. Such off-line processing may resemble or correspond to the way with which the police fines speeding persons based on pictures taken by automated speed cameras. In such cases, the ticket system abuser can be yet identified 570 during inspection for the off-line processing. In some cases, the identification can be handled using the credential information provided by the user device 110. This may be particularly the case if the credential information contains an image and identity of the user 115 so that the ticket inspector 145 can sufficiently ensure the identity of the abusive person.

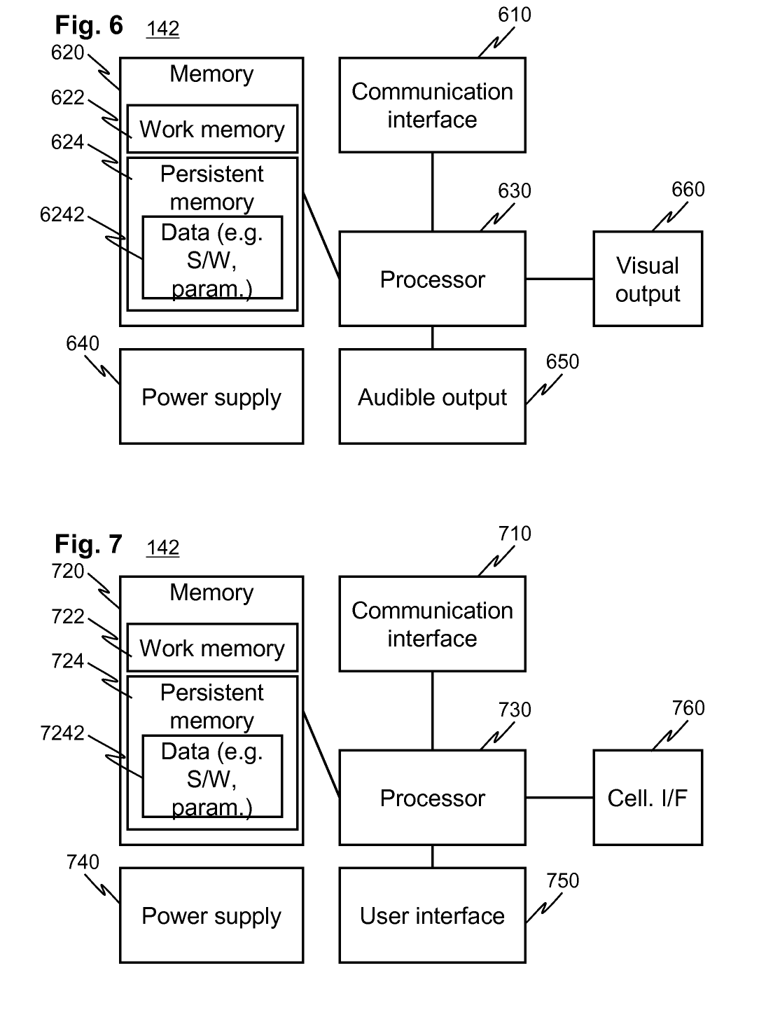

FIG. 6 shows a block diagram of a ticket inspection member 142 according to an example embodiment. The ticket inspection member 142 comprises a communication interface 610 for communications with user devices 110 and inspection devices 140; a memory 620; a processor 630 for controlling operation of the ticket inspection member 142; and a power supply 640 for powering the ticket inspection member 142.

In an example embodiment, the memory 620 comprises any of: a work memory 622; persistent or non-volatile memory 624; and/or data 6242 such as computer executable program code or software, parameters, encryption data.

In an example embodiment, the communication interface 610 is a near-field communication interface. In another example embodiment, the communication interface is an infrared communication interface; universal serial bus (USB) interface; Bluetooth™; and/or wireless local area networking (WLAN) interface.

In an example embodiment, the power supply 640 comprises an electric energy reservoir such as a battery or capacitor. In an example embodiment, the power supply 640 comprises a wireless energy harvester configured to obtain energy wirelessly e.g. from any of: light; radio signals; varying magnetic field; and/or varying electric field. In an example embodiment, the power supply 640 and the communication interface 610 are commonly formed or integrated into one unit.

In an example embodiment, the memory 620 comprises any of: random access memory (RAM); static RAM (SRAM); dynamic RAM (DRAM); phase-change random access memory (PRAM); erasable programmable read only memory (EPROM); electrically erasable programmable read-only memory (EEPROM or Flash ROM); and any combination thereof.

In an example embodiment, the processor 630 comprises any of: a microprocessor; a digital signal processor (DSP); an application specific integrated circuit (ASIC); a field programmable gate array; a microcontroller or any combination of such elements.

FIG. 6 further shows an audio output device 650 such as an electrostatic speaker (e.g. piezo element) or an electro-dynamic speaker; a visual output device 660 such as a display; and/or one or more signal lights; and a user input 670 such as a button or touch screen, for use in some example embodiments. For example, in case of near-field communication, simply the tapping together of the ticket inspection member 142 and the user device 110 or the inspection device 140 can be used to start suitable processing. However, in case of e.g. Bluetooth or RFID, the user input 670 can be actuated substantially simultaneously with a given event such as issuing a user command with the user device 110 or with the inspection device 140. The event can be e.g. issuing user input with the user device 110 or a moment of time indicated by the user device (e.g. by countdown).

FIG. 7 shows a block diagram according to an example embodiment of a unit 700 suited for operation as a ticket inspection device 140 and/or as the user device 110. The unit 700 can be formed of a smart phone; personal digital assistant; laptop computer; tablet computer; navigation device; electronic book; hand-held game console; and/or a portable electronic device. The unit 700 comprises a communication interface 710 for communications with the inspection member 142; a memory 720; a processor 730 for controlling operation of the unit; a power supply 740 for powering the unit 700; a user interface 750; and a telecommunication interface 760 such as a cellular interface for operating over a 2G, 3G or 4G telecommunication network, for example (e.g. global system for mobile communication (GSM), interim standard (IS)-95, personal digital cellular (PDC), wideband code division multiple access (W-CDMA)).

The components of the unit 700 can be similar or even identical with those described with reference to FIG. 6, except that typically the unit 700 has a power supply 740 that is independent of simultaneously receiving energizing emission from any external device. Also the circuitries of the unit 700 can be computationally more efficient than those described with reference to FIG. 6.

Without in any way limiting the scope, interpretation, or application of the claims appearing below, a technical effect of one or more of the example embodiments disclosed herein is that digital tickets can be inspected without necessitating the handing over of the digital ticket holding device or the digital ticket inspection device for bringing these together. Another technical effect of one or more of the example embodiments disclosed herein is that a single ticket inspection person can simultaneously start and supervise plural digital ticket inspection chains in which one person hands over a digital ticket inspection member from one to another. Another technical effect of one or more of the example embodiments disclosed herein is that the routes or services used can be recorded with the digital ticket holding devices without expensive structures. Yet another technical effect of one or more of the example embodiments disclosed herein is that the abusive use of digital tickets can be efficiently revealed by digital ticket inspection.

Embodiments of the present invention may be implemented in software, hardware, application logic or a combination of software, hardware and application logic. In an example embodiment, the application logic, software or an instruction set is maintained on any one of various conventional computer-readable media. In the context of this document, a “computer-readable medium” may be any non-transitory media or means that can contain, store, communicate, propagate or transport the instructions for use by or in connection with an instruction execution system, apparatus, or device, such as a computer, with one example of a computer described and depicted in FIG. 6. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the before-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the foregoing describes example embodiments of the invention, these descriptions should not be viewed in a limiting sense. Rather, there are several variations and modifications which may be made without departing from the scope of the present invention as defined in the appended claims.

1-32. (canceled)

33. An apparatus, comprising:
a communication interface;
a memory; and
a processor configured to:
cause obtaining by the communication interface of credential information from a user device for digital ticket inspection;
cause storing of the credential information or a derivative thereof in the memory;
cause communicating by the communication interface to a digital ticket inspection device the credential information or the derivative thereof.

34. The apparatus of claim 33, wherein the processor is further configured to cryptographically identify the apparatus as an authorized device to the user device.

35. The apparatus of claim 34, wherein the processor is further configured to receive the credential information from the user device responsively to the identifying of the apparatus as an authorized device to the user device.

36. The apparatus of claim 33, wherein the processor is further configured to verify the credential information.

37. The apparatus of claim 36, wherein the processor is further configured to cause issuing of a success indication if the verifying of the credential information confirms that the user device holds a valid digital ticket.

38. The apparatus of claim 33, wherein the processor is further configured to cause the communication interface to communicate a challenge to the user device and to cause storing in the memory the challenge or an identifier thereof with or as part of the credential information.

39. The apparatus of claim 33, wherein the processor is further configured to determine ticket parameters from the credential information and to check consistency of the credential information with acceptable range or ranges of ticket parameters.

40. The apparatus of claim 39, wherein the ticket parameters comprise time validation time of a digital ticket.

41. The apparatus of claim 33, wherein the communication interface is a near field communication interface.

42. An apparatus, comprising:
a first communication interface;
a second communication interface;
a processor configured to:
cause using the first communication interface to obtain from a back-end cryptographic information configured to enable digital inspection of whether credential information shows a valid digital ticket; and
cause sending the received cryptographic information using the second communication interface to a digital ticket inspection member for verifying of validity of credential information of user devices by the digital inspection member or cause:
receiving of credential information using the second communication interface from the digital inspection member and verifying of validity of the credential information by the processor.

43. The apparatus of claim 42, wherein the processor is further configured to cause the first communication interface to send to the back-end results of the verifying of the validity of credential information.

44. The apparatus of claim 42, wherein the cryptographic information comprises one or more challenges.

45. The apparatus of claim 42, wherein the cryptographic information comprises an authentication assertion suited for authenticating the digital ticket inspection member to the user devices.

46. A method comprising:
obtaining credential information from a user device for digital ticket inspection;
storing the credential information or a derivative thereof; and
communicating to a digital ticket inspection device the credential information or the derivative thereof.

47. The method of claim 46, further comprising performing the method in an apparatus and cryptographically identifying the apparatus as an authorized device to the user device.

48. The method of claim 47, comprising receiving the credential information from the user device responsively to the identifying of the apparatus as an authorized device to the user device.

49. The method of claim 46, further comprising verifying the credential information.

50. The method of claim 47, further comprising issuing of a success indication if the verifying of the credential information confirms that the user device holds a valid digital ticket.

51. A method, comprising:
obtaining from a back-end cryptographic information configured to enable digital inspection of whether credential information shows a valid digital ticket; and
sending the received cryptographic information to a digital ticket inspection member for verifying of validity of credential information of user devices by the digital inspection member or causing:
receiving of credential information from the digital inspection member and verifying of validity of the credential information.

52. A computer program product comprising a computer-readable medium bearing computer program code embodied therein for use with a computer, the computer program code comprising:
code for obtaining credential information from a user device for digital ticket inspection;
code for storing the credential information or a derivative thereof; and
code for communicating to a digital ticket inspection device the credential information or the derivative thereof;
when the computer program is run on a processor.
